(19) United States
(12) Patent Application Publication
(10) Pub. No.: US 2013/0060645 A1
(43) Pub. Date: Mar. 7, 2013

(54) GENERATING FEES AND REVENUES FROM MODIFIED LOGOS

(71) Applicant: Roy Baladi, New York, NY (US)

(72) Inventor: Roy Baladi, New York, NY (US)

(21) Appl. No.: 13/224,308

(22) Filed: Sep. 1, 2011

(51) Int. Cl. G06Q 30/00

(52) U.S. Cl. 705/14.71; 705/14.69

(57) ABSTRACT

Provided are methods and systems for creating and generating modified logo images. In one example embodiment, the method includes obtaining an original logo image associated with a first brand, wherein the original logo image has a corresponding recognition value, and identifying one or more areas of the original logo image for modification. The method further includes obtaining one or more replacement images associated with a second brand, wherein the one or more replacement images meet one or more predetermined criteria and replacing the one or more areas of the original logo image with at least a portion of the one or more replacement images to create a modified logo image. The method further includes displaying the modified logo image, wherein one or more parties selected from a party associated with the one or more replacement images or a party associated with the original logo image is receiving a fee or is generating a revenue that is directly associated with the modified logo from a third party.

### TECHNICAL FIELD

This disclosure relates generally to leasing logo images and, more particularly, to methods and systems for creating and displaying modified logo images and collecting fees.

### BACKGROUND

Logos are graphic marks or images commonly used by businesses, organizations and even individuals to aid and promote their instant public recognition. Some logos may be purely graphic and include only a symbol and/or icon (e.g., Apple's apple and Nike's swoosh). Other logos include the name of the organization (e.g., Coca-Cola and Dell). This type of logo is sometimes referred to as a logotype or word-mark. Still other logos include a combination of graphics and names (e.g., Harley Davidson and NBA).

As stated above, the purpose of the logo is to promote and help create instant public recognition for their owners and use this recognition to drive sales of the logo owners, which are often referred to as brand owners. For example, when people see Nike's swoosh, they think about various athletic apparel, such as running shoes. However, this approach and purpose substantially limits the usage of each logo to one owner or one line of products. As such, logos' values are primarily in the form of goodwill. Owners can only recoup this goodwill value in the form of additional product sales and higher prices, which may take a substantial amount of time to occur. Occasionally, brand owners sell their entire brand, including corresponding logos, to other owners, who may choose to continue using these logos in a similar manner. Overall, there are no methods for generating direct revenues from logos without selling them outright.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are methods and systems for displaying a modified logo image. An example method may include obtaining an original logo image associated with a first brand, wherein the original logo image has a corresponding recognition value, identifying one or more areas of the original logo image for modification, obtaining one or more replacement images associated with a second brand, wherein the one or more replacement images meet one or more predetermined criteria, replacing the one or more areas of the original logo image with at least a portion of the one or more replacement images to create a modified logo image, and displaying the modified logo image, wherein one or more parties selected from a party associated with the one or more replacement images or a party associated with the original logo image is paying a fee, either party being able to generate revenue that is directly associated with the modified logo from a third party.

In certain embodiments, a method of displaying a modified logo image involves obtaining an original logo image associated with a first brand, identifying one or more areas of the original logo image for modification, and obtaining one or more replacement images associated with a second brand. The original logo image has a corresponding recognition value, which may be associated with the first brand. Furthermore, the one or more replacement images may need to meet one or more predetermined criteria. The method may also involve replacing the one or more areas of the original logo image with at least a portion of the one or more replacement images to create a modified logo image and then displaying the modified logo image, wherein a party associated with the one or more replacement images is paying a fee. The party providing one or more replacement images may be any party selected by the owner of the original logo image or a service provider facilitating the overall process and transaction. For example, the highest bidder may be selected as the party providing the one or more replacement images. Other criteria may be used as well. The fee paid by such party may come in any form of incentive, for example, an actual payment amount or certain values associated with the replacement images (e.g., another logo incorporated in the replacement images, and so forth). In certain embodiments, one or more areas of the original logo image represent a part of the original logo. These one or more areas may correspond to a background of the original logo image.

In certain embodiments, the method also involves determining a fee associated with displaying the modified logo image. For the purposes of this disclosure, the fee may be based on one or more of the following criteria: a ratio of the one or more areas to an area of the original logo, a number of views of the modified logo image, a number of purchased product items associated with the modified logo image, a period of time of displaying the modified logo image, the recognition value of the original logo, a fixed price, a royalty, shares, warrants, and an asset having monetary value. In certain embodiments, one or more replacement images may correspond to a product image or represent the actual product item.

In certain embodiments, the modified logo image is displayed on a website associated with the original logo image. The original logo image may include a website area (for example, a frame or a banner). The one or more areas of the original logo may represent an entire area of the original logo image. Replacing one or more areas of the original logo involves retaining a portion of a shape of the original logo. A portion of the one or more replacement images may be positioned outside of a boundary of the original logo image.

In certain embodiments, identifying one or more areas of the original logo image for modification involves specifying an initial fee estimate for displaying the modified logo. The one or more predetermined criteria that are met by the one or more replacement images may include a color scheme of the one or more replacement images relative to the one original logo image, conformation of the one or more replacement images to the first brand, and content of the one or more replacement images. In certain embodiments, a method involves authorizing replacement of the one or more areas of the original logo images with the one or more replacement images based on meeting the one or more predetermined criteria. The first brand and the second brand may belong to different companies (business entities that do not share ownership in the first and second brands).

Provided also is a system for displaying a modified logo image. The system may include at least one processor configured to obtain an original logo image associated with a first brand. The original logo image has a corresponding recognition value. The same or another processor may be configured to identify one or more areas of the original logo image for modification and to obtain one or more replacement images associated with a second brand. The one or more replacement images meet one or more predetermined criteria. At least one processor may be configured to replace the one or more areas of the original logo image with the one or more replacement images to create a modified logo image. Furthermore, the same or another processor may be configured to display the modified logo image. A party associated with the one or more replacement images is paying a fee.

Provided also is a computer-readable medium having instructions stored thereon, which when executed by one or more computers cause the one or more computers to obtain an original logo image associated with a first brand. The original logo image has a corresponding recognition value. The computer-readable medium also has instructions to identify one or more areas of the original logo image for modification and to obtain one or more replacement images associated with a second brand. The one or more replacement images meet one or more predetermined criteria. Furthermore, the computer-readable medium also has instructions to replace the one or more areas of the original logo image with the one or more replacement images to create a modified logo image and to display the modified logo image. A party associated with the one or more replacement images is paying a fee. As stated above, various parties may be selected. For example, a replacement image may be a well-known web icon (e.g., Google icon). A company that is less recognizable in the web commerce may be used this well-known web icon to increase its exposure. At the same time, this company pays a fee to the owner of the web icon. In further exemplary embodiments, modules, subsystems, or devices can be adapted to perform the recited steps. Other features and exemplary embodiments are described below.

### BRIEF DESCRIPTION OF THE DRAWINGS

Embodiments are illustrated by way of example and not limitation in the figures of the accompanying drawings, in which like references indicate similar elements and in which:

FIG. 1 is a schematic representation of an original logo image, replacement image, and modified logo image, according to an example embodiment.

FIG. 2 is a schematic representation of another original logo image, replacement image, and modified logo image, according to another example embodiment.

FIG. 3 shows a block diagram illustrating a system environment suitable for creating and displaying a modified logo image as well as collecting payments associated with displaying the modified logo image, according to an example embodiment.

FIG. 4 is a diagram of a service provider system, according to an example embodiment.

FIG. 5 is a process flow diagram showing a method for creating and displaying a modified logo image, according to an example embodiment.

FIG. 6 is a diagrammatic representation of an example machine in the form of a computer system within which a set of instructions, for the machine to perform any one or more of the methodologies discussed herein, is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The proposed methods and systems may be used to generate direct revenue by brand owners from their logos having certain recognition values that may be relied on by other brand owners. Instead of selling an entire brand to another owner, the brand owner may generate some revenues from the logos associated with the brand while retaining the ownership of the brand. For example, a brand owner that has a well-recognized logo may have only a limited number of product items and/or marketing channels. At the same time, other entities may have strong product lines and/or marketing channels but have poor recognition by customers, which ultimately limits sales. Customers may be unaware of this other brand and simply ignore product items associated with this brand. For example, customers may instead buy competitors' products associated with more recognized brands even though these competitors' products may be less valuable and/or more expensive. It can take long time and substantial advertisement spending to build up a brand and make logos associated with this brand more recognizable. Overall, a product lifecycle may not always be in line with a marketing lifecycle, and companies with strong brands may have fewer products available than can be supported by these brands, while companies with strong product lines may not have sufficient recognition. This discrepancy cannot be easily corrected by building and scaling down brands since marketing processes are relatively slow and expensive.

In addition to using a logo, a brand owner can use one or more product images of its products to as an original logo image. The product images may be used in addition or instead of logos, e.g., Nike's swoosh may be used instead of or in addition to an image of Nike's shoes.

The proposed systems and methods allow companies with less recognizable brands and products to rent or lease logos having high recognition values in order to boost sales of their product items. A logo may be rented for a certain time period. A logo may be rented by one or multiple entities at the same time. These techniques may be used to enhance recognition of the lessee's logos to a certain level, at which point the lessee can revert back to its own logo to continue operating.

The original logo image associated with a first brand may be modified using one or more replacement images associated with a second brand to create a modified logo image. The modified logo image is then displayed to promote product sales or other purposes of the second brand based on public recognition of the original logo. The original logo image remains sufficiently recognizable in the modified logo image. The second brand owner may pay a fee to the original logo's owner based on the recognition value of the original logo, display options of the modified logo image, product sales corresponding to the second brand, and other factors.

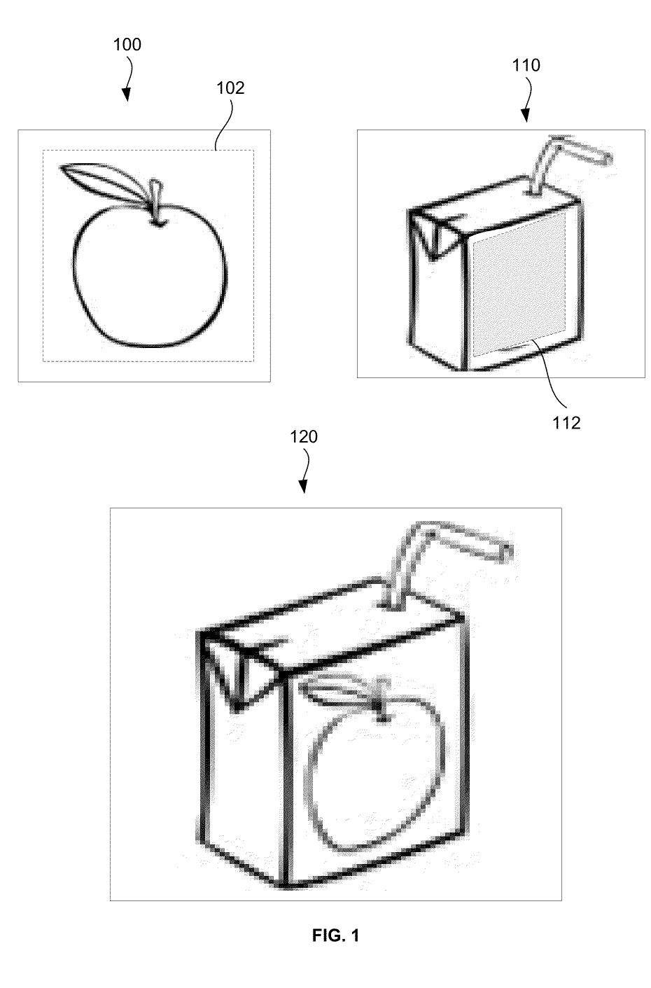

These techniques are best illustrated using examples. FIG. 1 is a schematic representation of an original logo image 100, replacement image 110, and modified logo image 120, according to an example embodiment. In this example, original logo image 100 is an image of an apple. Original logo image 100 is associated with a first brand and has a certain recognition value. This recognition value may be valuable to a second brand owner that may be in the business of selling apple juice. The second brand owner may provide a replacement image 110, which is used to create a modified logo image 120. In this example, a portion 112 of replacement image 110 (i.e., a side of the box) is replaced with a portion 102 of original logo image 100. Alternatively, it can be stated that an outside boundary of original logo image 100 (i.e., an area outside of portion 102) is replaced with an outside portion of replacement image 110 (i.e., an area outside of portion 112). Alternatively, it can be stated that original logo image 100 is modified using replacement image 110 to create a modified logo image 120, or that original logo image 100 is integrated with replacement image 110 to create a modified logo image 120.

A brand and/or products associated with original logo image 100 may be complementary to a brand and/or products associated with replacement image 110, such that a customer may think about future types of products when seeing and recognizing the original logo image 100. In the example presented in FIG. 1, original logo image 100 may show an actual apple, while the brand associated with that logo may be in business of growing, selling, processing, and/or distributing apples or apple products. In other embodiments, a brand and/or products associated with original logo image 100 may be unrelated to a brand and/or products associate with replacement image 110. Returning to the example presented in FIG. 1, original logo image 100 may still show an apple, but the brand associated with that logo may be in business of designing, building, and selling computers. In another example, original logo image 100 may have no relationship to products associated with modified logo image 120 (e.g., Nike's swoosh used on an apple juice bottle).

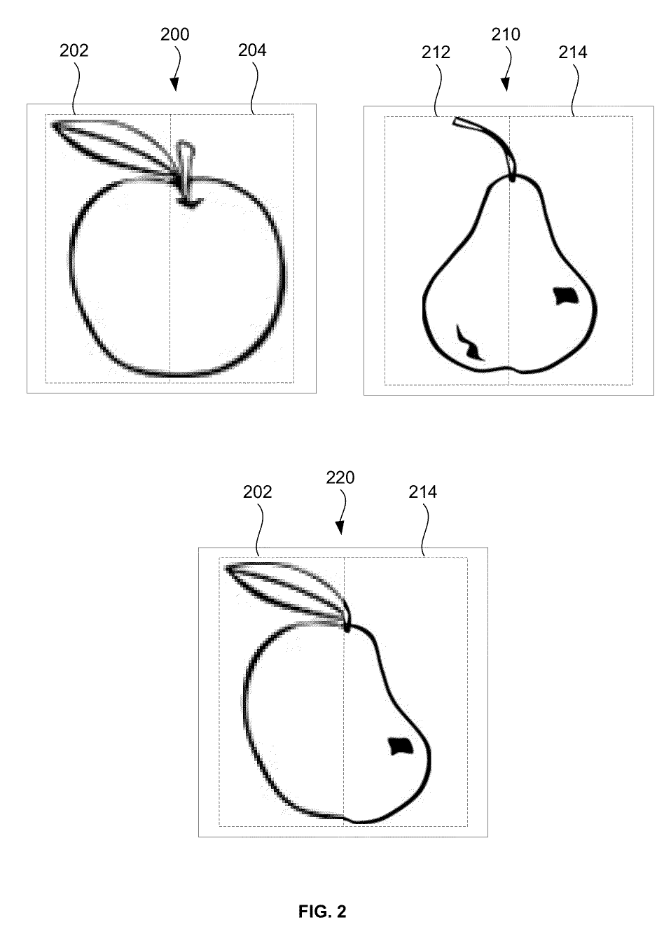

FIG. 2 is a schematic representation of another original logo image 200, replacement image 210, and modified logo image 220, according to another example embodiment. In this example, a left portion 202 of original logo image 200 is retained, while a right portion 204 of original logo image 200 is replaced with a right portion 214 of replacement image 210. Right portion 204 of original logo image 200 and left portion 212 of replacement image 210 are not used to create modified logo image 220, which includes only left portion 202 of original logo image 200 and right portion 214 of replacement image 210

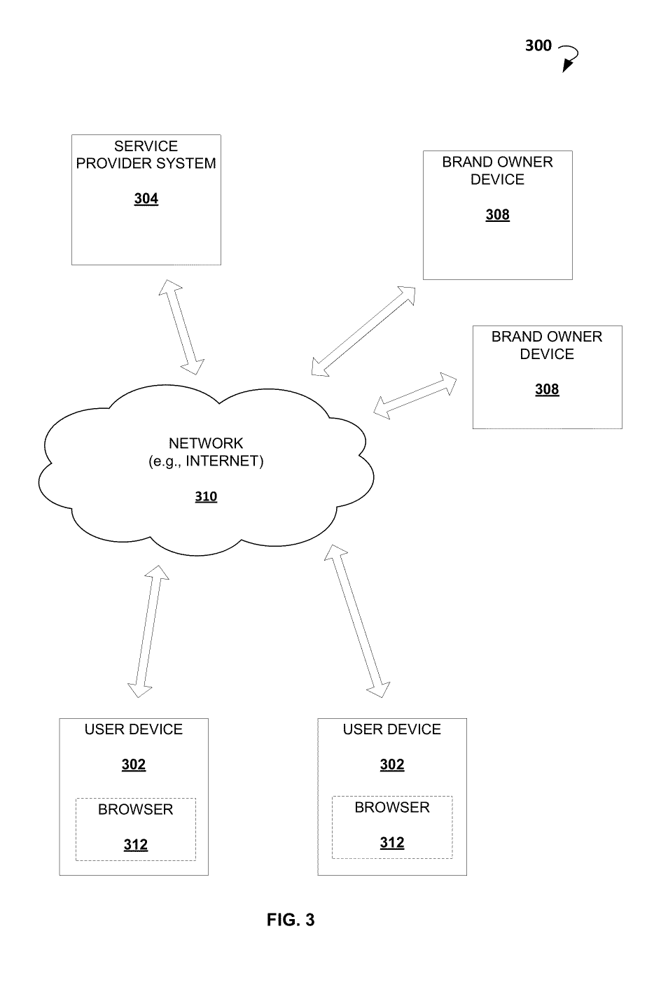

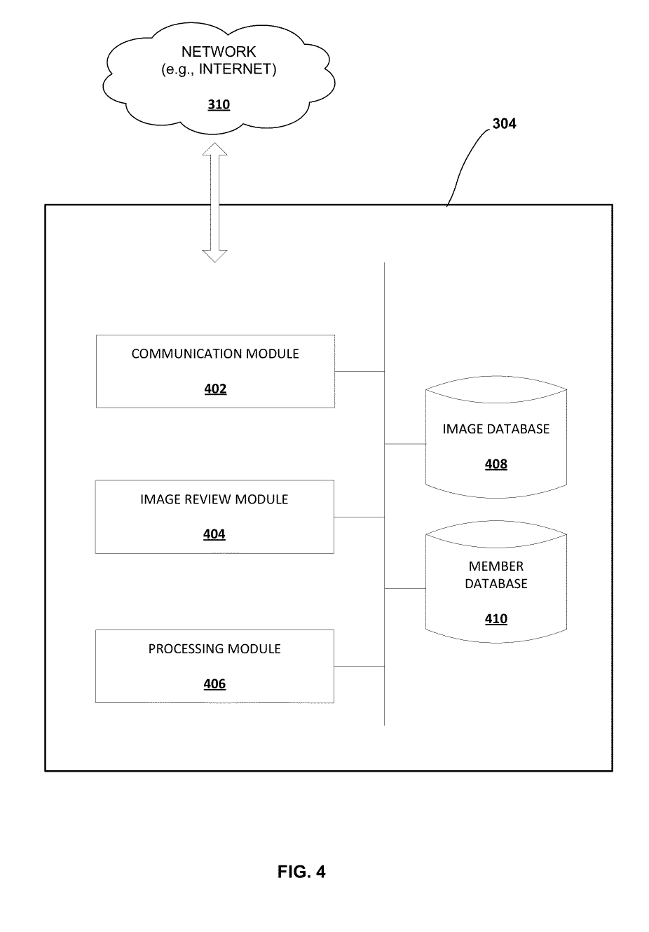

Methods of creating and displaying modified logo images as well as collecting payments for displaying the modified logo images may be implemented on one or more computer systems, as will now be explained with reference to FIGS. 3 and 4. Specifically, FIG. 3 shows a block diagram illustrating a system environment 300 suitable for such techniques. The system environment 300 includes one or more user devices 302, a service provider system 304, one or more brand owner devices 308, and a network 310 for providing network communication and coupling the above mentioned devices and systems.

The network 310 is a network of data processing nodes interconnected for the purpose of data communication, which may be utilized to communicatively couple various components of the environment 300. The network 310 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port, such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS, CDPD (cellular digital packet data), RIM (Research in Motion, Limited) duplex paging network, Bluetooth radio, or an IEEE 802.11-based radio frequency network. The network 310 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

As used herein, the term “user device” refers to a computer, a laptop, a tablet computer, a portable computing device, a PDA, a handheld cellular phone, a mobile phone, a smart phone, a handheld device having wireless connection capability, or any other electronic device. The user devices 302 may be used to upload one or more replacement images associates with a second brand, control creation a modified logo image, view of the modified logo image, submitting payment and/or perform various other functions described below. In one example, the user devices 302 may be configured to browse original logo images stored at a database of the service provider system 304. In some embodiments, the user devices 302 may comprise a browser 312 providing the ability to browse websites and/or other content generated by service provider system 304. A similar computer system and other abovementioned devices may be used as brand owner devices 308. The brand owner devices 308 may be used for uploading original logo images and other functions described below.

The service provider system 304, according to example embodiments disclosed herein, may be configured to provide one or more interfaces for users and brand owners. For example, the service provider system 304 may interact with the brand owner devices 308 to receive original logo images, receive and/or modify predetermined criteria for replacement images, display modified logo images, receive authorizations, transmit payment information, and perform various other functions. In the same or other embodiments, the service provider system 304 may interact with the user devices 302 to display original logo images, receive replacement images, receive commands for creating modified logo images, display and process criteria for replacement images, display modified logo images, accept payment information, and perform various other functions, such as functions related to image manipulation, image modification methods, and functions related to fee/payment/royalty agreements. For the purposes of this document, a “fee” can be defined as any asset or value that is transferred to the owner of the original logo image in exchange for use of this image and modifying this image. Examples of such fees may include credit card or back account charges, transactions related to third party payment switches (e.g., PayPal), and various other forms of compensations. The service provider system 304 may be implemented on a server having multiple modules and databases. One such example is described in detail below with reference to FIG. 4.

FIG. 4 is a diagram of the service provider system 304, according to an example embodiment. In this embodiment, the service provider system 304 may include a communication module 402, an image review module 404, a processing module 406, an image database 408, and a member database 410. In other embodiments, the service provider system 304 may include additional, fewer, or different modules for various applications. Furthermore, all modules can be integrated within a single system, or, alternatively, can be remotely located and optionally be accessed via a third party.

According to example embodiments, the users and/or brand owners may register with the service provider system 304 and create a member profile. The membership details may be stored in the member database 410. The membership profile stored in the database 410 may store entities' names, descriptions of products and services offered, payment account information, login information, contact information, and other types of information. Original logo images, replacement images, and modified logo images may be stored in image database 408. These images may be associated with member accounts stored in the member database 410. In certain embodiments, the member database 410 and image database 408 are implemented as the same database.

The communication module 402 may be configured to connect the service provider system 304 to the one or more user devices 302 and to the one or more brand owner devices 308 via the network 310. The connection and data transfer may be provided via an Application Programming Interface (API) or some other methods, such as instructions from a user device to a service provider system's database bypassing an API. The communication module 402 may also be configured to provide communication functionality between all modules of the service provider system 304. In particular, the communication module 402 may receive user requests to upload replacement images and modify original logo images using these replacement images. The processing module 406 is configured to analyze the websites of online retailers to retrieve various product related information, such as pricing, description, and images. The processing module 406 may generate various product identifiers based on this information for use in shared shopping carts.

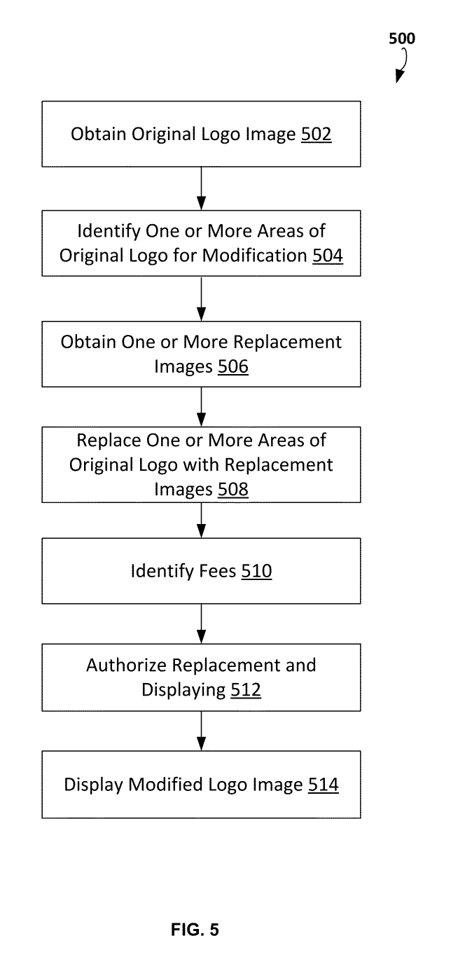

FIG. 5 is a process flow diagram showing a method 500 for displaying a modified logo image, according to an example embodiment. The method 500 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the service provider system 304.

The method 500 can be performed by the various modules discussed above with reference to FIG. 4. Each of these modules can comprise processing logic. It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of example embodiments.

As shown in FIG. 5, the method 500 may commence at operation 502 with obtaining an original logo image associated with a first brand. The original logo image may have a corresponding recognition value. In certain embodiments, the original logo image may have an associated recognition score to determine the value. Furthermore, original logo images may have various other descriptors that allows used to search and review the original logo images in the database. For example, the method 500 may involve an operation for selecting the original logo image from a library of logo images. In certain embodiments, the original logo image comprises a website area.

The method 500 may proceed with operation 504 that involves identifying one or more areas of the original logo image for modification. Two such examples are described above with reference to FIGS. 1 and 2. Overall, a portion of the original logo image may be modified. Alternatively, an entire original logo image may be used to create the modified logo image without any change to the logo image. In the latter embodiment, one or more replacement images may be modified or added to the original logo image. In other embodiments, the one or more areas of the original logo represent an entire area of the original logo image. For example, replacing the one or more areas of the original logo involves retaining a portion of a shape of the original logo. In certain embodiments, a portion of the one or more replacement images is positioned outside of a boundary of the original logo image. In certain embodiments, operation 504 also involves specifying an initial fee estimate for displaying the modified logo.

The method 500 may proceed with operation 506 that involves obtaining one or more replacement images associated with a second brand. The replacement images may be obtained from the image database described above with reference to FIG. 4 or uploaded by a user without any intermediate storage in the database. An obtained replacement image may need to meet one or more predetermined criteria before the image may be used for creating modified logos. These criteria may be set by a brand owner, service operator, or any other entity. For example, a replacement image may not include any negative content that may damage the value of the original logo image. Some other examples include a color scheme of the one or more replacement images relative to the original logo image, conformation of the one or more replacement images to the first brand, and content of the one or more replacement images. In certain embodiments, the one or more areas identified in operation 506 represent less than 50% of the original logo or, more specifically, less than 25%. Of course, other schemes of modifying images may be used as well. In the same or other embodiments, the one or more areas may correspond to a background of the original logo image.

In certain embodiments, the method 500 involves selecting one or more replacement images based on a bidding amount associated with the fee and/or based on the impact of the one or more images on a value of the first brand.

The method 500 may proceed with operation 508 that involves replacing one or more areas of the original logo image with at least a portion of the one or more replacement images to create a modified logo image. Two such examples are described above with reference to FIGS. 1 and 2. Furthermore, as stated above, in certain embodiments, an entire original logo image may be used to create the modified logo image without any change to the logo image. The one or more replacement images correspond to a product image.

The method 500 may proceed with operation 510 that involves identifying the fee associated with displaying the modified logo image. The fee may be identified based on one or more of the following criteria: a ratio of the one or more areas to an area of the original logo, a number of views of the modified logo image, a number of purchased product items associated with the modified logo image, a period of time of displaying the modified logo image, and recognition value of the original logo. In other embodiments, a brand owner may charge a flat fee for the service. Other payment schemes may be used as well. As stated above, an original logo image may be associated with a first brand, while one or more replacement images are associated with the second brand. In certain embodiments, the first brand and the second brand belong to different companies.

The method 500 may proceed with operation 512 that involves authorizing replacement of some areas of the original logo images with one or more replacement images. This authorization may be based on meeting the one or more predetermined criteria described above. Finally, the method 500 may involve operation 514 for displaying the modified logo image. In certain embodiments, the modified logo image is displayed on a website or in print associated with the original logo image.

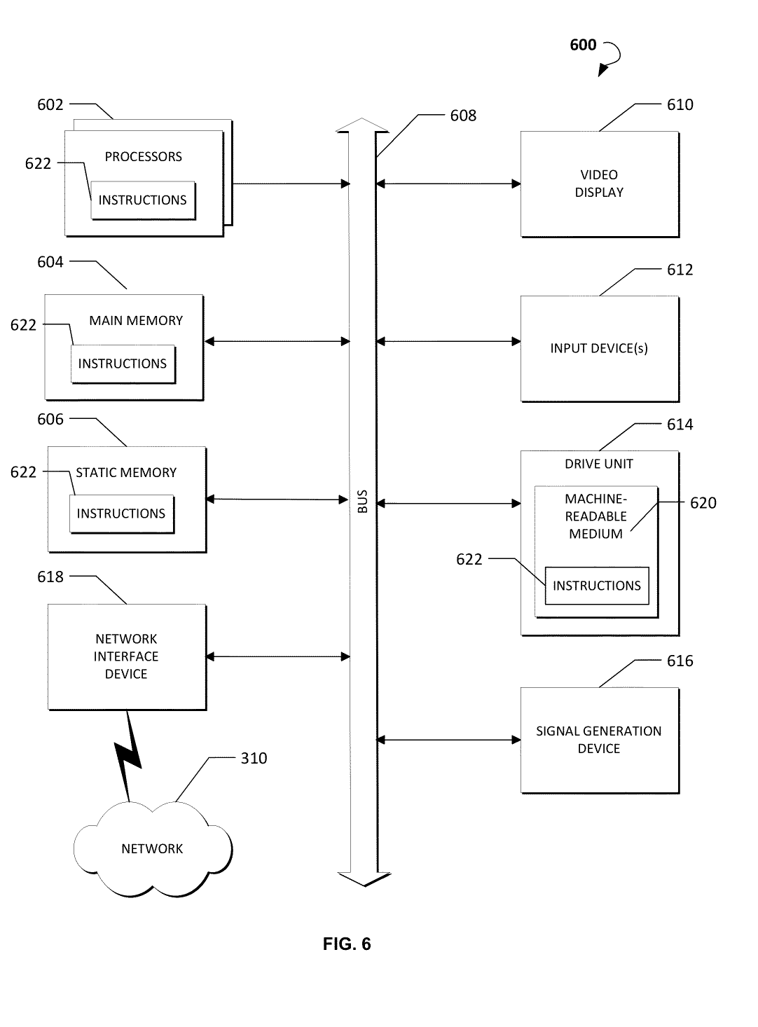

FIG. 6 shows a diagrammatic representation of a computing device for a machine in the example electronic form of a computer system 600, within which a set of instructions for causing the machine to perform any one or more of the methodologies discussed herein can be executed. In example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a PDA, a cellular telephone, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor or multiple processors 602 (e.g., a central processing unit (CPU), a graphics processing unit (GPU), or both), and a main memory 604 and a static memory 606, which communicate with each other via a bus 608. The computer system 600 can further include a video display unit 610 (e.g., a liquid crystal display (LCD) or cathode ray tube (CRT)). The computer system 600 also includes at least one input device 612, such as an alphanumeric input device (e.g., a keyboard), a cursor control device (e.g., a mouse), a microphone, a digital camera, a video camera, and so forth. The computer system 600 also includes a disk drive unit 614, a signal generation device 616 (e.g., a speaker), and a network interface device 618.

The disk drive unit 614 includes a computer-readable medium 620, which stores one, or more sets of instructions and data structures (e.g., instructions 622) embodying or utilized by any one or more of the methodologies or functions described herein. The instructions 622 can also reside, completely or at least partially, within the main memory 604 and/or within the processors 602 during execution thereof by the computer system 600. The main memory 604 and the processors 602 also constitute machine-readable media.

The instructions 622 can further be transmitted or received over the network 310 via the network interface device 618 utilizing any one of a number of well-known transfer protocols (e.g., Hyper Text Transfer Protocol (HTTP), CAN, Serial, and Modbus).

While the computer-readable medium 620 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media and other technologies that perform a similar function. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, methods and systems for creating and displaying modified logo images have been described. The disclosed technique provides a useful tool to enable people too easily for purchasing product items from multiple retailer websites within, for example, a social network without leaving the website of the network.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method of displaying a modified logo image, the method comprising:
obtaining an original logo image associated with a first brand, wherein the original logo image has a corresponding recognition value;
identifying one or more areas of the original logo image for modification;
obtaining one or more replacement images associated with a second brand, wherein the one or more replacement images meet one or more predetermined criteria;
replacing the one or more areas of the original logo image with at least a portion of the one or more replacement images to create a modified logo image; and
displaying the modified logo image, wherein one or more parties selected from a party associated with the one or more replacement images or a party associated with the original logo image is receiving a fee or is generating a revenue that is directly associated with the modified logo from a third party.

2. The method of claim 1, wherein the one or more areas correspond to a background of the original logo image.

3. The method of claim 1, further comprising identifying the fee associated with displaying the modified logo image.

4. The method of claim 3, wherein the fee is identified based on one or more criteria selected from a group consisting of:
a ratio of the one or more areas to an area of the original logo,
a number of views of the modified logo image,
a number of purchased product items associated with the modified logo image,
a period of time of displaying the modified logo image; and
the recognition value of the original logo.

5. The method of claim 1, wherein the fee is a selected from a group consisting of: a fixed price, a royalty, shares, warrants, and an asset having monetary value.

6. The method of claim 1, wherein the one or more replacement images correspond to a product image.

7. The method of claim 1, wherein the modified logo image is displayed on a website or in print.

8. The method of claim 1, wherein the original logo image comprises a website area.

9. The method of claim 1, wherein the one or more areas of the original logo represent an entire area of the original logo image.

10. The method of claim 9, wherein replacing the one or more areas of the original logo comprises retaining a portion of a shape of the original logo.

11. The method of claim 1, wherein a portion of the one or more replacement images are positioned outside of a boundary of the original logo image.

12. The method of claim 1, wherein identifying one or more areas of the original logo image for modification comprises specifying an initial fee estimate for displaying the modified logo.

13. The method of claim 1, wherein the one or more predetermined criteria are selected from a group consisting of:
a color scheme of the one or more replacement images relative to an original logo image,
conformation of the one or more replacement images to the first brand;
content of the one or more replacement images; and font changes.

14. The method of claim 1, further comprising authorizing replacement of the one or more areas of the original logo images with the one or more replacement images based on meeting the one or more predetermined criteria.

15. The method of claim 1, wherein the first brand and the second brand belong to different companies.

16. The method of claim 1, further comprising selecting the one or more replacement images based on a bidding amount/process associated with the fee.

17. The method of claim 1, further comprising selecting the one or more replacement images based on impact of the one or more images on a value of the first brand.

18. The method of claim 1, wherein obtaining the original logo image comprises selecting the original logo image from a library of logo images.

19. A system for displaying a modified logo image, the system comprising:
at least one processor configured to obtain an original logo image associated with a first brand, wherein the original logo image has a corresponding recognition value;
at least one processor configured to process or identify one or more areas of the original logo image for modification;
at least one processor configured to obtain one or more replacement images associated with a second brand, wherein the one or more replacement images meet one or more predetermined criteria;
at least one processor configured to replace the one or more areas of the original logo image with the one or more replacement images to create a modified logo image; and
at least one processor configured to display the modified logo image, wherein one or more parties selected from a party associated with the one or more replacement images or a party associated with the original logo image is receiving a fee or is generating a revenue that is directly associated with the modified logo from a third party.

20. A computer-readable medium having instructions stored thereon, which when executed by one or more computers, cause the one or more computers to:
obtain an original logo image associated with a first brand, wherein the original logo image has a corresponding recognition value;
identify one or more areas of the original logo image for modification;
obtain one or more replacement images associated with a second brand, wherein the one or more replacement images meet one or more predetermined criteria;
replace the one or more areas of the original logo image with the one or more replacement images to create a modified logo image; and
display the modified logo image, wherein one or more parties selected from a party associated with the one or more replacement images or a party associated with the original logo image is receiving a fee or is generating a revenue that is directly associated with the modified logo from a third party.
